(19) United States
(12) Patent Application Publication
(10) Pub. No.: US 2007/0073792 A1
(43) Pub. Date: Mar. 29, 2007

(54) System and method for removing residual data from memory

(76) Inventors: Tony Nichols, Erie, CO (US); Troy Carpenter, Superior, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/237,575

(22) Filed: Sep. 28, 2005

(51) Int. Cl. G06F 17/30

(52) U.S. Cl. 707/205

(57) ABSTRACT

Systems and methods for removing residual data on a protected computer are described. In one variation, the location of a directory structure is a file storage device of the protected computer are identified. Information from the directory structure is retrieved and analyzed to determine whether residual data exists in the directory structure. Any existing residual data is removed.

### RELATED APPLICATIONS

The present application is related to the following commonly owned and assigned applications: application Ser. No. 10/956,578, Attorney Docket No. WEBR-002/00US, entitled System and Method for Monitoring Network Communications for Pestware; application Ser. No. 10/956,573, Attorney Docket No. WEBR-003/00US, entitled System and Method For Heuristic Analysis to Identify Pestware; application Ser. No. 10/956,574, Attorney Docket No. WEBR-005/00US, entitled System and Method for Pestware Detection and Removal; application Ser. No. 11/145,593, Attorney Docket No. WEBR-009, entitled System and Method for Neutralizing Locked Pestware Files; application Ser. No. 11/104,202, Attorney Docket No. WEBR-011/00US, entitled System and Method for Directly Accessing Data From a Data Storage Medium; and application Ser. No. 11/145,592, Attorney Docket No. WEBR-024, entitled System and Method for Analyzing Locked Files, each of which is incorporated by reference in their entirety.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer system management. In particular, but not by way of limitation, the present invention relates to systems and methods for removing residual data on a protected computer.

### BACKGROUND OF THE INVENTION

Personal computers and business computers are continually attacked by trojans, spyware, and adware, collectively referred to as “malware” or “pestware.” These types of programs generally act to gather information about a person or organization-often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

In many cases, personal computers and business computers contain residual data that are unprotected from certain pestware processes. Software is available to remove residual data, however current techniques for complete residual data removal are time consuming and/or invasive to operation of the operating system. Even worse, some users elect not to completely remove residual data because they do not want to or cannot wait for the removal process to be completed. Accordingly, current software is not always able to completely remove residual data in a convenient manner and will most certainly not be satisfactory in the future.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Embodiments of the present invention include systems and methods for removing residual data from files on a protected computer. In one embodiment, a location of a directory structure in a file storage device of a protected computer is identified. Information is retrieved and analyzed to detect the presence of residual data in the file on the storage device while the operating system of the protected computer is limiting access to file. If residual data is found to exist in the directory structure, it is completely removed so it is not recoverable by any means.

In another embodiment, the invention may be characterized as a system for removing residual data from a file on a protected computer. A detection module identifies a location of a directory structure in a file storage device of a protected computer. A file access module retrieves information from the directory structure and a removal module analyzes the information to detect the presence of residual data in the file on the storage device while the operating system of the protected computer is limiting access to file. If the removal module determines that residual data is found to exist in the directory structure, it is completely removed so it is not recoverable by any means.

In yet embodiment, the invention may be characterized as a computer readable medium encoded with instructions for removing residual data from files in a storage device of a protected computer, the instructions including instructions for identifying a location of a directory structure in a file storage device of a protected computer, retrieving and analyzing information in order to detect the presence of residual data in the file on the storage device while the operating system of the protected computer is limiting access to file, and completely removing residual data, if it is found to exist in the directory structure, so it is not recoverable by any means.

These and other embodiments are described in more detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 illustrates a block diagram of a protected computer in accordance with one implementation of the present invention;

FIG. 2 is a flowchart of one method for accessing information from a plurality of files and data structures in accordance with an embodiment of the present invention; and

FIG. 3 is a flowchart of a method for identifying removing residual data in files that are not accessible by an operating system of the protected computer in accordance with another embodiment of the present invention.

FIG. 4 is a flowchart of a method for removing residual data from files that are not accessible by an operating system of the protected computer in accordance with another embodiment of the present invention.

### DETAILED DESCRIPTION

According to several embodiments, the present invention permits residual data from a file that is inaccessible via the operating system (e.g., because it is inaccessible by the operating system) to be accessed, analyzed and removed. In other words, while a file remains inaccessible via the operating system (e.g., because the file is being executed), several embodiments of the present invention allow the inaccessible file entry to be analyzed to determine if the file contains residual data, and if it does, then to remove the residual data of the ordinarily inaccessible file.

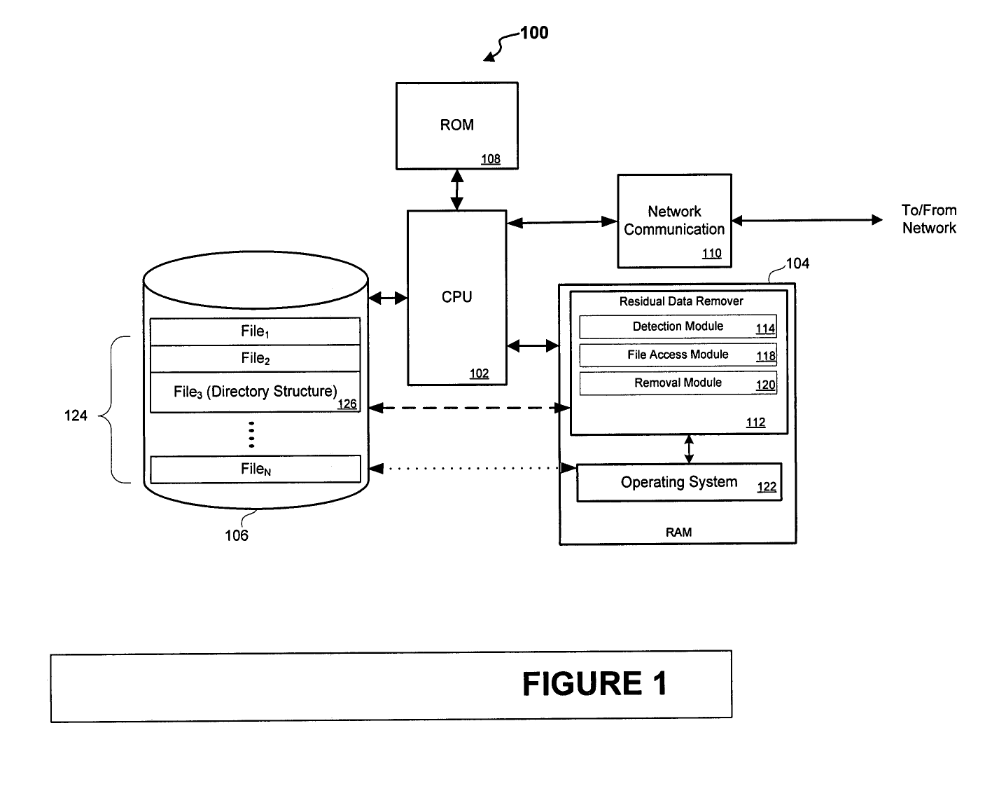

Referring first to FIG. 1, shown is a block diagram 100 of a protected computer/system in accordance with one implementation of the present invention. The term “protected computer” is used herein to refer to any type of computer system, including personal computers, handheld computers, servers, firewalls, etc. This implementation includes a CPU 102 coupled to memory 104 (e.g., random access memory (RAM)), a file storage device 106, ROM 108 and network communication 110.

As shown, the file storage device 106 provides storage for a collection of N files 124, which includes a directory structure 126. In one embodiment of the present invention, the directory structure 126 is a master file table (MFT) residing in a NT file system (NTFS). The file storage device 106 is described herein in several implementations as a hard disk drive for convenience, but this is certainly not required, and one of ordinary skill in the art will recognize that other storage media may be utilized without departing from the scope of the present invention. In addition, one of ordinary skill in the art will recognize that the storage device 106, which is depicted for convenience as a single storage device, may be realized by multiple (e.g., distributed) storage devices.

As shown, a residual data remover application 112 includes a detection module 114, a file access module 118 and a removal module 120, which are implemented in software and are executed from the memory 104 by the CPU 102. In addition, an operating system 122 is also depicted as running from memory 104.

The software 112 can be configured to operate on personal computers (e.g., handheld, notebook or desktop), servers or any device capable of processing instructions embodied in executable code. Moreover, one of ordinary skill in the art will recognize that alternative embodiments, which implement one or more components (e.g., the a residual data remover 112) in hardware, are well within the scope of the present invention.

Except as indicated herein, the operating system 122 is not limited to any particular type of operating system and may be operating systems provided by Microsoft Corp. under the trade name WINDOWS (e.g., WINDOWS 95, 98, 2000, NT and XP). Additionally, the operating system 122 may be an open source operating system such operating systems distributed under the LINUX trade name. For convenience, however, embodiments of the present invention are generally described herein with relation to WINDOWS-based systems. In light of the teaching disclosed herein, those of skill in the art can adapt these implementations for other types of operating systems or computer systems.

In accordance with several embodiments of the present invention, the file access module 118 enables data in one or more of the files 124 to be accessed notwithstanding one or more of the files 124 may be not accessible by the operating system 122. It is very difficult to assess whether the directory structure 126 contained residual data. In several embodiments of the present invention, however, the files 124 are accessible so that data in one or more of the files 124 may be analyzed (e.g., by the detection module 114) so as to identify whether any of the files 124 contain residual data.

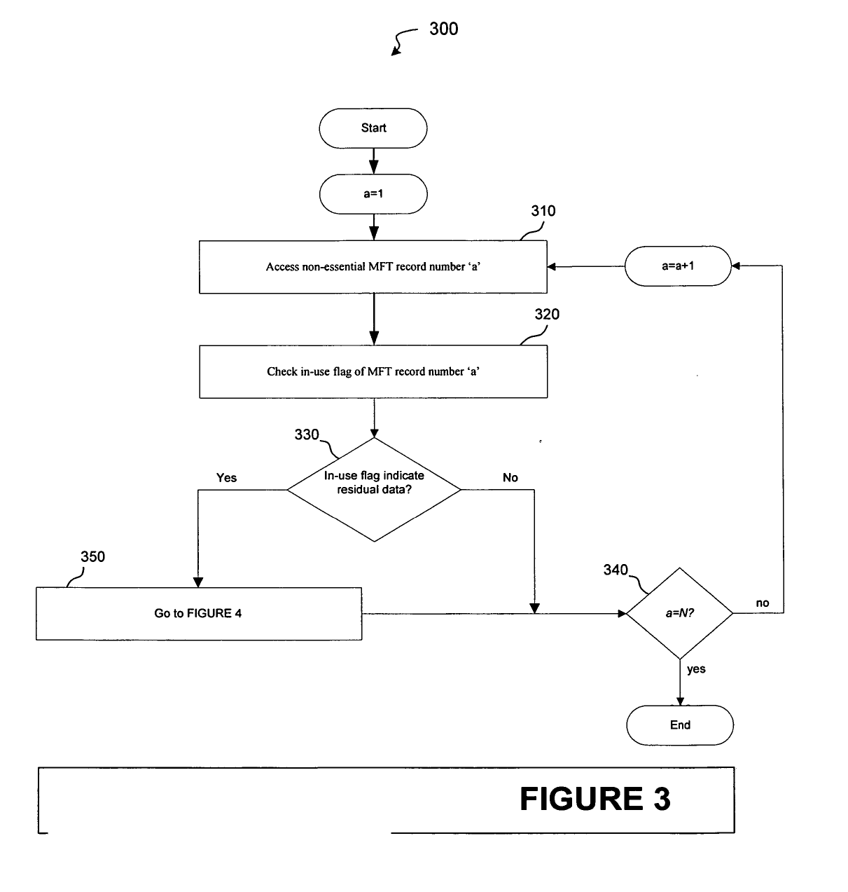

The removal module 120, as discussed further with reference to FIG. 3, enables residual data to be removed from files even if the operating system 122 is limiting access to those files. In operation for example, when a particular non accessible file entry is identified as containing residual data (e.g., the directory structure 126) the removal module 120 accesses directory structure entries that are not in-use and writes over the bytes associated with the directory structure entries using predetermined overwrite characters. This effectively covers up any residual data that may have remained in the directory structure entry after it was flagged as not in-use. In yet other variations, to further ensure residual data is fully removed, all information in the directory structure except for information necessary to recognize the directory structure is erased from the storage device 106.

It should be recognized that the file access module 118 and the removal module 120 are identified as separate modules only for ease of description and that the file access module 118 and the removal module 120 in several embodiments utilize the same components (e.g., the same collection of code) for carrying out similar functions.

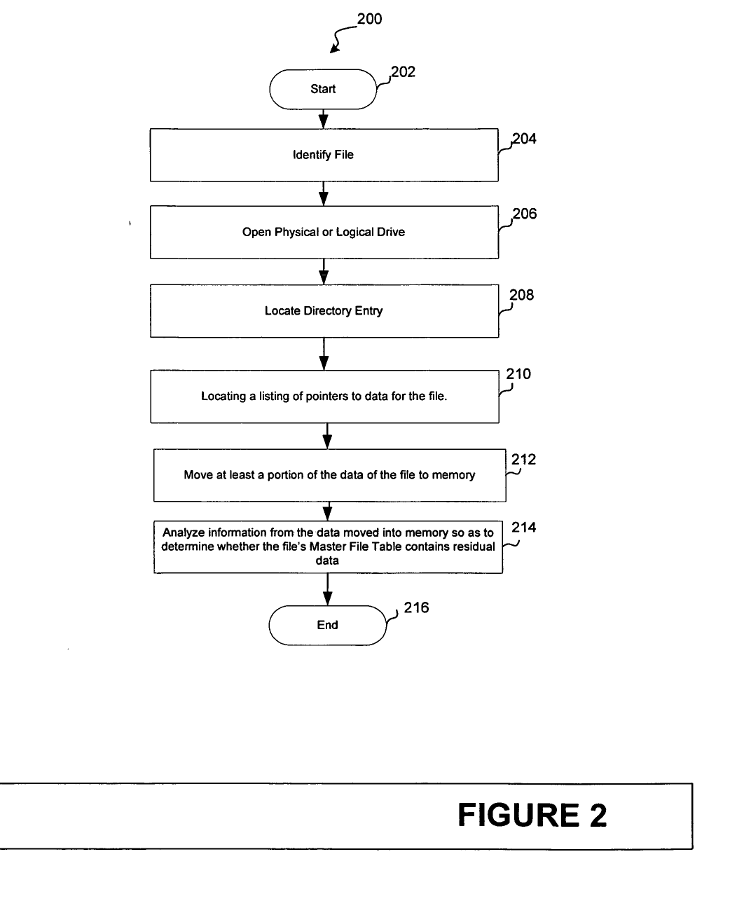

Referring next to FIG. 2, shown is a flowchart depicting steps traversed in accordance with a method for accessing data from files in the data storage device 106. In the exemplary method, a file (or directory structure) is initially identified as a inaccessible file entry (e.g., access via the operating system 122 is unavailable) (Blocks 202, 204).

In some embodiments, before steps are carried out to access data of an inaccessible file entry, the file path (e.g, a fully qualified path (FQP)) for the file is identified, but this is not required. Next, a physical or logical drive where the inaccessible files entry resides is opened for reading and writing (Block 206). In some instances, it is beneficial (when possible) to lock the volume so as to prevent the operating system 122 from doing any reading or writing while the file access module 118 is accessing data from the storage device 106.

In addition, in various embodiments, the content in a cache of the protected computer that is associated with the inaccessible file entry is flushed to the drive. This may be carried out as a safety measure so that if the file is determined to contain residual data, and the residual data is removed (as discussed further in reference to FIGS. 3 & 4) the residual data is not regenerated by the operating system 122.

In several embodiments, once a file is identified as a inaccessible file entry and the information about the volume where the file resides is obtained, then the directory entry for the file is located (Block 208).

In order to locate the directory entry and access data from the inaccessible file, information about where the volume's (i.e., the partition) files reside (e.g., C drive, D drive, etc.) is obtained. If the Physical Disk Mode is utilized, then sector zero, the partition table, is read so as to obtain the starting sectors for the volumes on the drive. In several embodiments, the Boot Record, which starts at logical sector zero, is accessed to obtain the BIOS Parameter Block (BPB). The BIOS parameter block includes the following useful information for an NTFS file system:

i. Bytes per sector

ii. Sectors per cluster

iii. Reserved sectors

iv. Media type

v. Hidden sectors

vi. Total sectors in Volume (or partition).

The following three pieces of information are available from the bios parameter block in an NTFS system:

vii. Logical cluster number for the MFT

viii. Clusters per file record segment

ix. Allocated size of the MFT.

When the storage device 106 is organized according to a NTFS file structure, in one embodiment, an iterative process of looking in subdirectories of the Fully Qualified Path is carried out until the directory entry of the inaccessible file entry is located.

Specifically, in this embodiment, beginning with the root directory, each directory entry in the Directory Index is read and the master file table (MFT) record for each entry is accessed and placed into memory. The validity of each MFT file record is determined, and if it is not valid, then the process is aborted. But, if the MFT file record of each entry is valid and the file name of the inaccessible file is reached in the directory index, the file entry for the inaccessible file is read from the directories index so as to obtain the MFT file record number for the inaccessible file entry.

The MFT includes several pieces of information that are useful in this process of locating the directory entry of the inaccessible file entry. As a consequence, in some embodiments, the MFT table is located by accessing the bios parameter block (BPB), and the first MFT File Record entry (0) is read into memory. The file record number 0 of the MFT includes information to locate all of the MFT File Record Locations given by the Data Attribution Record 0, which enables the clusters of the directory indexes to be located.

Once the directory entry for the inaccessible file is located (Block 208), then a listing of pointers to data for the file is located (Block 210). This listing is completed by decoding all of the data runs for the MFT entry 0. In the context of an NTFS file system, if the file's data resides within the MFT File Record itself, then a flag in the “Data Attribute” indicates whether the data for the file is resident or non-resident in the MFT file record. If the data for the inaccessible file is resident in the MFT file record, then the actual data for the file will be within the Data Attribute itself. In addition, other attributes within the MFT are, for example, “File Name” and “File Information.”

Once the location of inaccessible file entry is located, at least a portion of the data of the file entry is moved to memory (Block 212). The data from the file that is in memory is then analyzed so as to determine whether the file's Master File Table contains residual data (Block 214). It is to be understood that steps 212 and 214 can be performed in an alternate order where step 214 is performed before step 212. Additionally, it is to be understood that the description of FIG. 2 is by no way limiting the order or number of steps included in the present invention. Alternative numbers of steps, as well as the order of steps are well within the scope of the present invention.

Referring next to FIG. 3, shown is a flowchart, which depicts exemplary steps carried out when identifying residual data in a directory structure record of a file in accordance with an exemplary embodiment of the present invention. Residual data includes data that has been marked and deleted but has not been completely removed and is potentially recoverable with forensic software, disc viewing, disc recovery and spyware techniques. In other words, residual data includes data that still exists on the hard drive of a protected computer even after a user has chosen to delete the data.

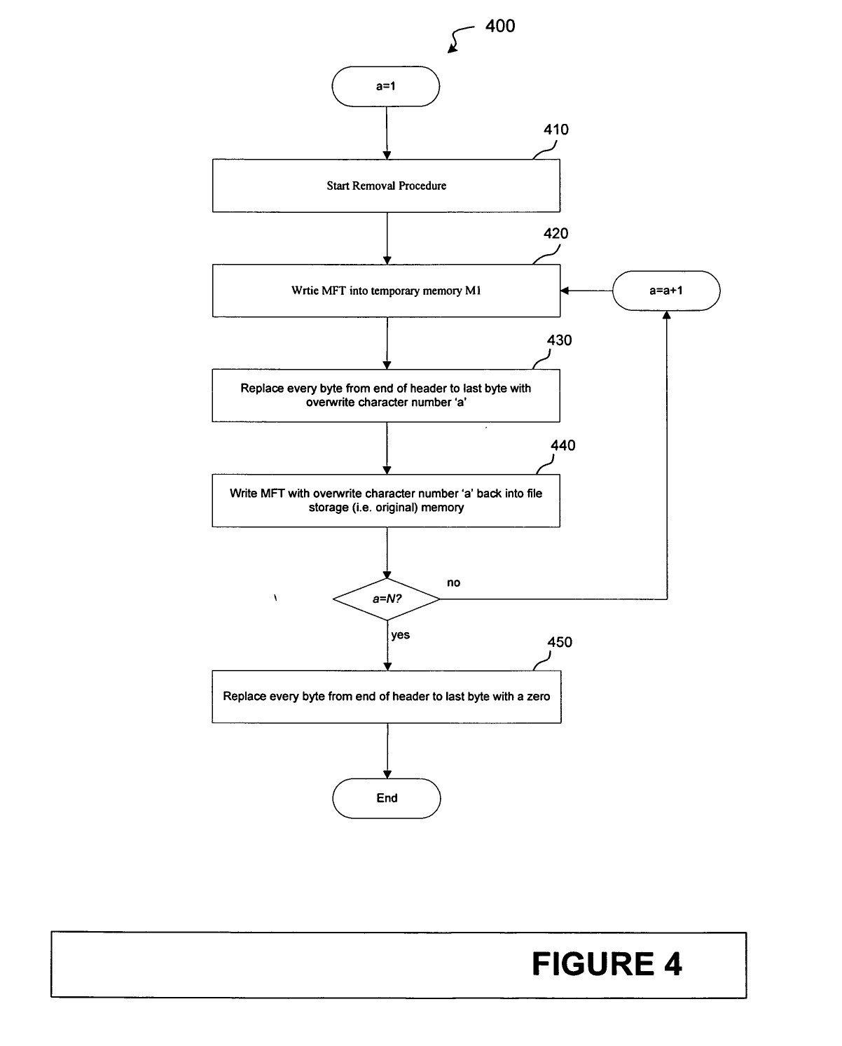

In one embodiment, the removal module 120 of FIG. 1 removes the residual data using the method described below with reference to FIG. 4. In the exemplary embodiment, the complete removal of residual data by the removal module 120 renders the residual data inaccessible such that it is unrecoverable by all known methods of data recovery. After the removal, the memory space that previously held the residual data appears to recovery methods as new memory (i.e., unused memory).

As shown in FIG. 3, the first non-essential MFT record is accessed (Block 310). An essential MFT record is one that is needed to recognize the MFT and access it for future use. A check is done to determine whether the in-use flag of the first non-essential MFT record is set to “in-use” or “not in-use” (Block 320). The setting is usually accomplished by a 1 or a 0, one of which indicates “in-use” and the other of which indicates “not in-use.” In one embodiment, an in-use flag that is set (e.g., set to an “in-use” state) indicates that the MFT record currently contains data that should not be removed (e.g., does not contain residual data). An in-use flag that is not set (e.g., set to a “not in-use” state) indicates that the MFT record may contain residual data that should be removed. In other embodiments a flag that is set may indicate that a MFT record contains residual data as opposed to non-residual data as exampled above.

If the in-use flag indicates the existence of residual data (Block 330), then the residual data is completely removed (Block 350) as described further herein with reference to FIG. 4. If there are more MFT records to check (Block 340), then process Blocks 310-350 are carried out until all N MFT records have been checked for residual data (Block 340).

While referring to FIG. 4, simultaneous reference will be made to FIG. 1 and FIG. 3. FIG. 4 depicts a flowchart 400 of a removal procedure for completely deleting residual data from a directory structure. If an MFT record is determined to contain residual data (Block 330), then the removal procedure is started (Block 410). In the exemplary embodiment, the MFT is saved to a secondary (i.e. temporary) memory M1 (Block 420). The MFT record is then accessed from memory M1 and every byte from the end of the MFT record header to the last byte of the MFT record are replaced with an overwrite character (Block 430). In the exemplary embodiment, the overwrite character is the pass 1 standard overwrite character from the Department of Defense 5022-22M erasure algorithm. One of ordinary skill in the art will recognize the various overwrite characters that can be used instead of the pass 1 standard overwrite character.

The updated MFT record with the overwrite character is then written back to the original memory of the MFT on the file storage device 106 (Block 440), and Blocks 420-440 are repeated for an N number of overwrite characters. In the exemplary embodiment, Blocks 420-440 are repeated for a second, third, and fourth overwrite character. In this embodiment, the second, third, and fourth overwrite characters are the pass 2, pass 3 and pass 4 standard overwrite characters from the Department of Defense 5022-22M erasure algorithm, respectively. One of ordinary skill in the art will recognize that there are various overwrite characters that can be used instead of the pass 2, 3 and 4 standard overwrite characters. One of ordinary skill in the art will also recognize that fewer or more overwrite characters than the four overwrite characters above can be used.

After Blocks 420-440 are repeated for N overwrite characters, the MFT record stored in memory M1 (now with the Nth overwrite character) is accessed and every byte from the end of the MFT record header to the last byte of the MFT record is replaced with a zero (Block 450). At this point, a hard link count is set to zero in memory M1; the MFT record header size in memory M1 is set to the same size as the “MFT real size;” and the size of the MFT record in memory M1 is set to the MFT record size on the file storage disk 106. In addition, each entry in the Update Sequence Array (i.e. fix-up values) are replaced with zero in memory M1, and an optional step of adding one to the Sequence number is performed in some embodiments. Finally, the MFT record in memory M1 is written back to the original memory location in file storage disk 106. Following the complete removal of all residual data in the MFT, the locked volume is unlocked, the physical drive (or logical drive handle) is closed and a reboot is performed if necessary.

In conclusion, the present invention provides, among other things, a system and method for managing pestware. Those skilled in the art can readily recognize that numerous variations and substitutions may be made in the invention, its use and its configuration to achieve substantially the same results as achieved by the embodiments described herein.

For example, the processes depicted in FIGS. 2, 3 and 4 are shown in separate drawings merely to show that each process may be implemented separately and independently, but these process may be integrated into one seamless process. It should also be recognized that the order of many of the steps described with reference to FIGS. 2, 3 and 4 may be varied without adversely affecting the performance of implementations of the present invention. Moreover, one of ordinary skill in the art will recognize that residual data in a file may be removed for practical purposes by implementing less than all of the steps enumerated in FIGS. 3 and 4. Accordingly, there is no intention to limit the invention to the disclosed exemplary forms. Many variations, modifications and alternative constructions fall within the scope and spirit of the disclosed invention as expressed in the claims.

What is claimed is:

1. A method for removing residual data on a protected computer while substantially circumventing an operating system of the protected computer comprising:
identifying a location of a directory structure in a file storage device of the protected computer, wherein the directory structure is stored in an original memory space;
retrieving information from the directory structure;
analyzing the information from the directory structure to determine whether the residual data exists in the directory structure; and
removing the residual data if it exists in the directory structure.

2. The method according to claim 1, wherein
the directory structure operates in an NT File System,
the directory structure is a master file table (MFT), and
the residual data resides in at least one directory structure record that is selected from the group consisting of at least one directory structure record available to be rewritten and at least one directory structure record that is not in-use.

3. The method according to claim 1, wherein the analyzing comprises:
scanning the directory structure;
identifying a location of at least one directory structure record; and
accessing the at least one directory structure record to determine if the residual data exists in the at least one directory structure record.

4. The method of claim 1, wherein the residual data is all data in the directory structure except for data that allows the operating system to recognize the directory structure as a type of directory structure.

5. The method of claim 1, wherein the removing comprises erasing the residual data so the residual data cannot be recovered by a means selected from the group consisting of spyware, forensic software, disc viewing, and disc recovery.

6. The method of claim 1, wherein the removing comprises erasing the residual data from a disk drive memory so as to leave the disk drive memory of the protected computer in a state as if the residual data had never existed.

7. The method of claim 1, wherein the removing comprises:
saving at least one record of the directory structure to a temporary memory space, wherein the at least one record contains the residual data;
accessing the at least one record;
updating, in the temporary memory space, every byte between the end of a header and a last byte of the at least one record with a first overwrite character, thereby creating a first updated at least one record; and
saving the first updated at least one record to the original memory space.

8. The method of claim 7, wherein the removing further comprises:
accessing the first updated at least one record;
updating, in the temporary memory space, every byte between the end the of the header and the last byte of the first updated at least one record with a second overwrite character, thereby creating a second updated at least one record;
saving the second updated at least one record to the original memory space;
accessing the second updated at least one record;
updating, in the temporary memory space, every byte between the end the of the header and the last byte of the second updated at least one record with a third overwrite character, thereby creating a third updated at least one record;
saving the third updated at least one record to the original memory space;
accessing the third updated at least one record;
updating, in the temporary memory space, every byte between the end the of the header and the last byte of the third updated at least one record with a fourth overwrite character, thereby creating a fourth updated at least one record; and
saving the fourth updated at least one record to the original memory space.

9. A computer-readable medium comprising executable instructions that remove residual data on a protected computer while substantially circumventing an operating system of the protected computer, wherein the executable instructions comprise instructions to:
identify a location of a directory structure in a file storage device of the protected computer, wherein the directory structure is stored in an original memory space;
retrieve information from the directory structure;
analyze the information from the directory structure to determine whether the residual data exists in the directory structure; and
remove the residual data if it exists in the directory structure.

10. The computer-readable medium of claim 9, wherein
the executable instructions operate in an NT File System,
the directory structure is a master file table (MFT),
the residual data resides in at least one directory structure record that is selected from the group consisting of at least one directory structure record available to be rewritten and at least one directory structure record that is not in-use, and
the residual data is all data in the directory structure except for data that allows the operating system to recognize the directory structure as a type of directory structure.

11. The computer-readable medium of claim 9, wherein the executable instruction to analyze the information from the directory structure to determine whether the residual data exists in the directory structure includes executable instructions to:
scan the directory structure;
identify a location of at least one directory structure record; and
access the at least one directory structure record to determine if the residual data exists in the at least one directory structure record.

12. The computer-readable medium of claim 9, wherein the executable instruction to remove the residual data if it exists in the directory structure includes executable instructions to erase the residual data so the residual data cannot be recovered by a means selected from the group consisting of spyware, forensic software, disc viewing, and disc recovery.

13. The computer-readable medium of claim 9, wherein the executable instruction to remove the residual data if it exists in the directory structure includes executable instructions to:
save at least one record of the directory structure to a temporary memory space, wherein the at least one record contains the residual data;
access the at least one record;
update, in the temporary memory space, every byte between the end of a header and a last byte of the at least one record with a first overwrite character, thereby creating a first updated at least one record; and
save the first updated at least one record to the original memory space.

14. The computer-readable medium of claim 13, wherein the executable instruction to remove the residual data if it exists in the directory structure further includes executable instructions to:
access the first updated at least one record;
update, in the temporary memory space, every byte between the end the of the header and the last byte of the first updated at least one record with a second overwrite character, thereby creating a second updated at least one record;
save the second updated at least one record to the original memory space;
access the second updated at least one record;
update, in the temporary memory space, every byte between the end the of the header and the last byte of the second updated at least one record with a third overwrite character, thereby creating a third updated at least one record;
save the third updated at least one record to the original memory space;
access the third updated at least one record;
update, in the temporary memory space, every byte between the end the of the header and the last byte of the third updated at least one record with a fourth overwrite character, thereby creating a fourth updated at least one record; and
save the fourth updated at least one record to the original memory space.

15. A system of removing residual data on a protected computer while substantially circumventing an operating system of the protected computer, comprising:
a detection module configured to:
identify a location of a directory structure in a file storage device of the protected computer, wherein the directory structure is stored in an original memory space;
a file access module configured to:
retrieve information from the directory structure; and
a removal module configured to:
analyze the information from the directory structure to determine whether the residual data exists in the directory structure; and
remove the residual data if it exists in the directory structure.

16. The system of claim 15, wherein
the system is an NT File System,
the directory structure is a master file table (MFT),
the residual data resides in at least one directory structure record that is selected from the group consisting of at least one directory structure record available to be rewritten and at least one directory structure record that is not in-use, and
the residual data is all data in the directory structure except for data that allows the operating system to recognize the directory structure as a type of directory structure.

17. The system of claim 15, wherein the removal module configured to analyze the information from the directory structure to determine whether the residual data exists in the directory structure is further configured to:
scan the directory structure;
identify a location of at least one directory structure record; and
access the at least one directory structure record to determine if the residual data exists in the at least one directory structure record.

18. The system of claim 15, wherein the removal module configured to remove the residual data if it exists in the directory structure is further configured to erase the residual data so the residual data cannot be recovered by a means selected from the group consisting of spyware, forensic software, disc viewing, and disc recovery.

19. The system of claim 15, wherein the removal module configured to remove the residual data if it exists in the directory structure is further configured to:
save at least one record of the directory structure to a temporary memory space, wherein the at least one record contains the residual data;
access the at least one record;
update, in the temporary memory space, every byte between the end of a header and a last byte of the at least one record with a first overwrite character, thereby creating a first updated at least one record; and
save the first updated at least one record to the original memory space.

20. The system of claim 19, wherein the removal module configured to remove the residual data if it exists in the directory structure is further configured to:
access the first updated at least one record;
update, in the temporary memory space, every byte between the end the of the header and the last byte of the first updated at least one record with a second overwrite character, thereby creating a second updated at least one record;
save the second updated at least one record to the original memory space;
access the second updated at least one record;
update, in the temporary memory space, every byte between the end the of the header and the last byte of the second updated at least one record with a third overwrite character, thereby creating a third updated at least one record;
save the third updated at least one record to the original memory space;
access the third updated at least one record;
update, in the temporary memory space, every byte between the end the of the header and the last byte of the third updated at least one record with a fourth overwrite character, thereby creating a fourth updated at least one record; and
save the fourth updated at least one record to the original memory space.
